(19) United States
(12) Patent Application Publication
(10) Pub. No.: US 2008/0134210 A1
(43) Pub. Date: Jun. 5, 2008

(54) Distributed Computer

(76) Inventor: Nektarios Georgalas, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/594,421

(22) PCT Filed: Mar. 23, 2005
(86) PCT No.: PCT/GB05/01101

§ 371 Date: Sep. 26, 2006

(30) Foreign Application Priority Data
Mar. 30, 2004 (GB) 0407150.2

(51) Int. Cl. G06F 9/44

(52) U.S. Cl. 719/318

(57) ABSTRACT

distributed computer operating in accordance with a distributed application program made up from user-modifiable event-driven component processes is disclosed. Known distributed computers of this type carry out the modification of processes at a single computer leading to a lack of robustness in the operation of the distributed computer as a whole. This problem is alleviated by providing each computer which runs a component (621) of the distributed application program with a component modification facility. The operation of the component (621) in reaction to the receipt of an event message is modified in accordance with policies stored in a database (623). In order to simplify the task of the user in writing such policies, a component details registry (627) is also provided which gives the names and parameters of procedures or methods offered by the component (621).

The present invention relates to a distributed computer and to a method of operating a distributed computer.

The benefits of writing a software program as a plurality of separate modules (an activity known as structured programming) have been well-known for decades. This approach was subsequently taken further with the introduction of the idea of creating large programs from new combinations of modules written for earlier programs. Using previously prepared software modules in this way leads to an increased speed of software production, and hence cheaper application programs.

Often the previously written modules are organised into collections called libraries. In developing a program for a stand-alone computer, it is well-known for a program called a linker to link an object generated by a compiler from a program written by a programmer with an object taken from such a library. Each of these objects comprises machine code and a symbol definition table. The symbol definition table in each object contains so-called exported symbols which refer to functions or modules that are present in the object and imported symbols which are functions or variables which are called or referenced by the object but which are not defined within the object. The linker program associates imported and exported symbols in order to generate the machine code which represents the entire program.

Modern operating system environments (e.g. Windows) allow dynamic linking which involves the associations (links, in other words) being made at the time the program is loaded or run. The dynamic nature of this linking means that an update to a library routine (in Windows these are .dll files) will be reflected each time that an application which includes that library routine is subsequently loaded.

The above relates to stand-alone computers—an early example of distributed computing was implemented by researchers at Xerox PARC in the early 1980's. They developed software for calling modules on other computers so that the modules appeared to the programmer as if they were on the same computer as the program which called them. This software is described in the paper “Implementing Remote Procedure Calls”, Birrell A., and Nelson, B., ACM Transactions on Computer Systems, Vol. 2, No. 1, February 1984, Pages 39-59. That paper explains that Remote Procedure Calls are achieved by the addition of a communications program, and client and server ‘stub’ modules which together cause the selected procedure to be carried out on the remote computer, and return the result of the procedure to the application program. In writing a distributed application, a programmer prepares the user and server programs and one or more on interface modules (a list of procedure names together with the types of the parameters the procedure takes and the type of the result it produces). The user is provided with software which automatically generates the ‘stub’ modules on the basis of the interface module prepared by the programmer.

Software which:

a) provides ‘stubs’ to enable the interoperation of software modules executing on different machines;
b) makes the existence and capabilities of modules on different computers known; and
c) offers communication and marshalling of data between programs;
is referred to herein as middleware.

The use of Remote Procedure Calls allows a library function to be provided remotely and utilised by several computers. The library can then consist of separate executable files (the middleware providing the required linking functionality).

To combine the benefits of object-oriented programming and distributed computing, the Java programming language from Sun Microsystems provides a Remote Method Invocation facility to the programmer. This is an example of middleware. Since this only works between objects written in the Java programming language, there is no need for the programmer to learn a special Interface Definition Language—Java's own interface definitions are used instead.

To extend the benefits of software re-use and distributed computing, the Common Object Request Broker Architecture (CORBA) promulgated by the Object Management Group in the early 1990's standardises middleware allowing a programmer to program an application constructed from modules/programs written in different languages and executing on different computers. In CORBA-compliant systems, code which enables the use of procedures (methods) offered by remote objects, called an ‘Object Request Broker’ (ORB) is provided. To enable ‘binding’ between a calling object and a called object, every ORB must provide an ‘Interface Repository’. The ‘Interface Repository’ contains descriptions of the methods provided by objects, those descriptions being written in an Interface Definition Language (IDL) which is similar to the declarative statements made in a C++ program. Suitable stub modules can then be created automatically on the basis of the IDL specifications. CORBA uses a Common Data Representation to transfer the parameters values used in method calls and responses.

More recently, Web Services technology has come to the fore. Web Services provides another form of middleware—but offers an improvement over CORBA in that the eXtensible Markup Language (XML) is used to transfer parameter values between computers. This provides a flexible means of defining the parameters that are passed.

A problem exists in that distributed applications constructed using any other the above forms of middleware are difficult to develop & modify. In order to alter their operation, it is necessary to alter a software module (an object), and then re-compile and re-start it. Depending on the middleware used, and the complexity of the alteration, it may also be necessary to generate an interface specification for the altered software module, and compile that interface specification. This is especially undesirable for modern e-commerce applications which are often required to run continuously.

In order to alleviate this problem, Sharma Chakravarthy and others proposed the adoption of an idea previously used in some database management software. In a paper “ECA Rule Processing in Distributed and Heterogeneous Environments”, in the proceedings of the International Symposium on Distributed Objects and Applications, 1999, they suggest that the operation of a distributed application might be altered at run-time by making its operation dependent on Event-Condition-Action rules stored in a database. These are said to confer an “active” capability on the distributed computer described therein. The proposed system is a distributed computer each computer of which has CORBA middleware installed on it. One computer within the distributed computer is designated a Composite Event Detection and Rule execution (CEDaR) server computer which:

(i) receives events (i.e. structured data representing the characteristics of an event) from a software component forming part of the distributed application running on a separate computer, and in response to that;
(ii) finds one or more ‘rules’ stored at the CEDaR server which indicate condition-action pairs for responding to such events,
(iii) calls another method/procedure to evaluate the condition (possibly passing the event as a parameter), and
(iv) calls another method/procedure (again, possibly passing the event as a parameter) to carry out the action if the condition is true.

The action is normally the execution of a software component (or at least a procedure or method within that software component) on one of the other computers making up the distributed computer. In an alternative design, the action can be the execution of software contained within a local software library on the CEDaR server (such a library can be updated with new software without having to stop the execution of the distributed application program).

To make the distributed application adaptable, updateable ECA rules are interpreted at runtime. Of course, there is little point in interpreting an updated ECA rule at run-time, unless the executing program adapts its execution at run-time in order to reflect the change that has occurred in the database. To meet this requirement, the CEDaR server and the other computers in the distributed computer proposed by Chakravarthy uses OrbixWeb from Iona Technologies (a CORBA-compliant Object Request Broker which enables communication between components executing as part of the distributed application program). OrbixWeb offers a Dynamic Invocation Interface which allows a programmer to write the executing program in such a way that the method named in the action field of the ECA rule stored in the database is automatically selected at runtime. Furthermore, the ability to use events defined whilst the application is running is provided by using the Java Reflection Application Programmer Interface (API) provided as part of the Java programming language package provided by Sun Microsystems.

The reliance on a single server to evaluate rules, and to call condition evaluation and rule execution procedures means that Chakravarthy's distributed computer is highly dependent on the performance of that single server and sends and receives an amount of traffic which grows with the size of the distributed application being run.

According to a first aspect of the present invention, there is provided a distributed computer comprising at least two interconnected computers, each of said computers storing:

i) component process code executable to provide a process forming part of a distributed software application;
ii) event messaging code executable to receive one or more event messages from another of said computers;
iii) event reaction rule storage code executable to store, in an updateable store, one or more event reaction rules which include one or more calls upon functionality in said component process in reaction to the receipt of said event message;
iv) event reaction rule interpretation code executable to operate said computer to respond to the receipt of an event message in accordance with said event reaction rules;
v) event reaction rule modification code executable to allow a user to modify said event reaction rules stored in said updateable store.

By storing, at each of two or more computers within a distributed computer, each of which computers executes one or more components forming part of a distributed application program running on said computer, one or more event reaction rules specifying calls to functionality within said component to be made in reaction to the receipt of an event message, and enabling a user to update the event reaction rules, a distributed computer with robust and yet easily updateable operation is provided.

Preferably, said event messages are structured in accordance with event schema data accessible to each of said computers. This allows the computer to check that the event is of the correct data type.

Further preferably, said event messages comprise a combination of event data and mark-up data. This simplifies the processing required to unpack the constituent parts of the event data at the receiving computer.

In a preferred embodiment, said event messages are sent as encoded text. This allows the use of simple text-based messaging protocols such as the HyperText Transfer Protocol. In particular, the event messages can be formed in accordance with an eXtensible Markup Language schema.

Preferably, said process modification code is executable to configure said process by specifying a method or procedure to be called and the parameters to accompany said method or procedure call. In some embodiments, said specified method or procedure is running on the other of said computers. This allows for the re-use of code installed on other computers, whilst maintaining the relative simplicity offered by having the event reaction rules and modifiable component stored on the same computer.

According to a second aspect of the present invention, there is provided a method of operating a distributed computer comprising a plurality of interconnected computers, said method comprising operating each of said computers to:

i) execute one or more component processes which form part of a distributed program running on said distributed computer;
ii) store one or more event reaction rules;
iii) provide a user with an interface allowing updating of said event reaction rules; and
iv) configure the operation of said component process in reaction to the reception of an event in dependence upon said event reaction rules.

Specific embodiments of the present invention will be now described, by way of example only, with reference to the accompany drawings in which:

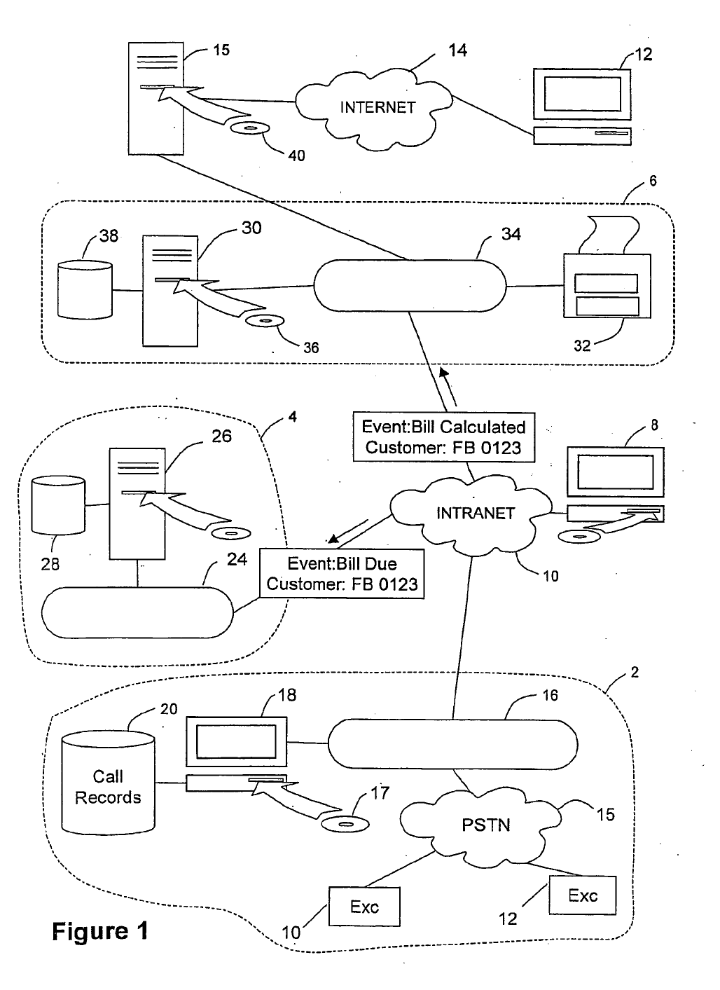

FIG. 1 illustrates the hardware used in a first embodiment of the present invention;

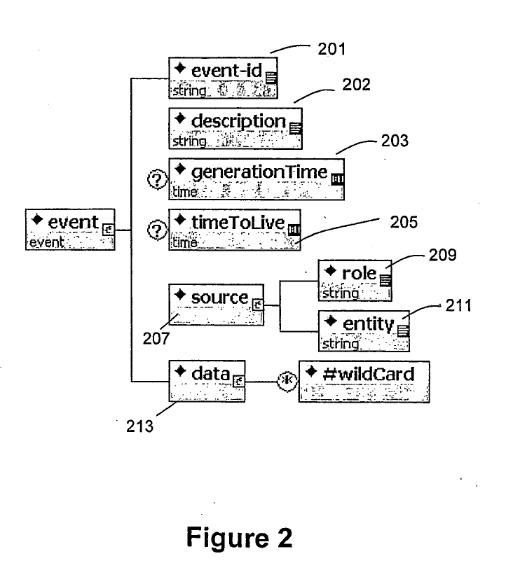

FIG. 2 illustrates the overall structure of an event data type according to a first embodiment of the present invention;

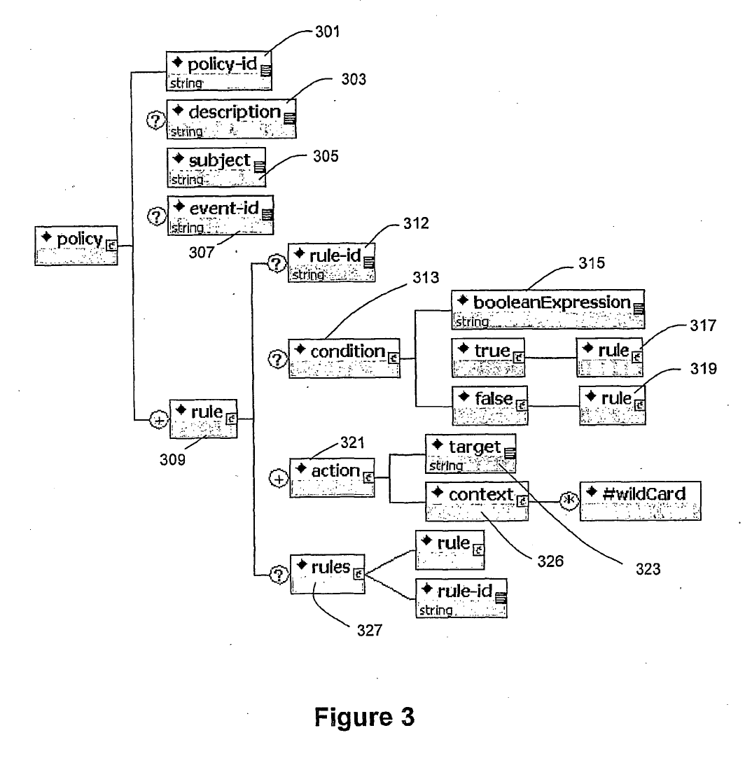

FIG. 3 illustrates the overall structure of a policy data type according to a first embodiment of the present invention;

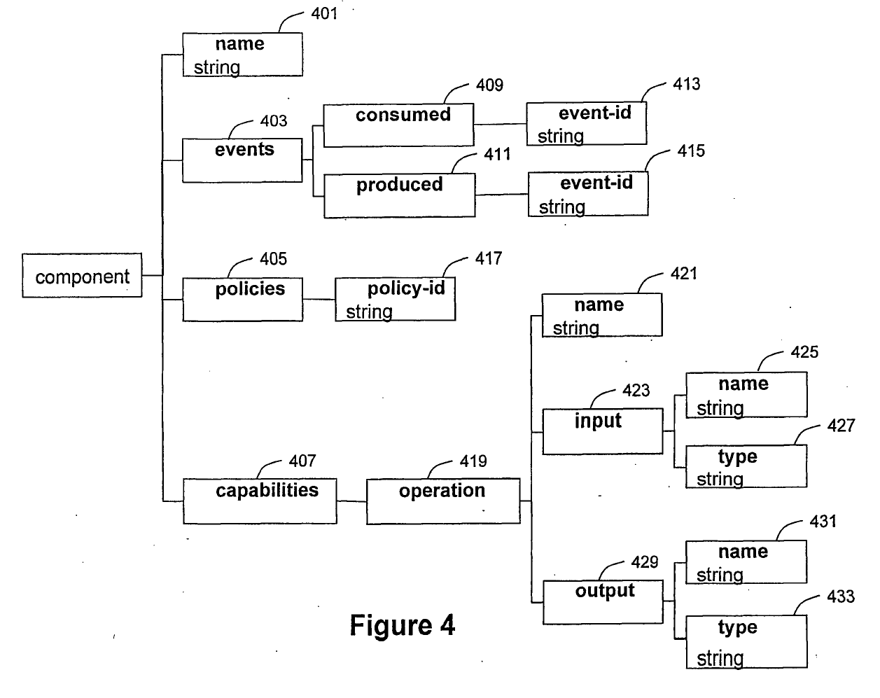

FIG. 4 illustrates the structure of a component description data used in the first embodiment; and

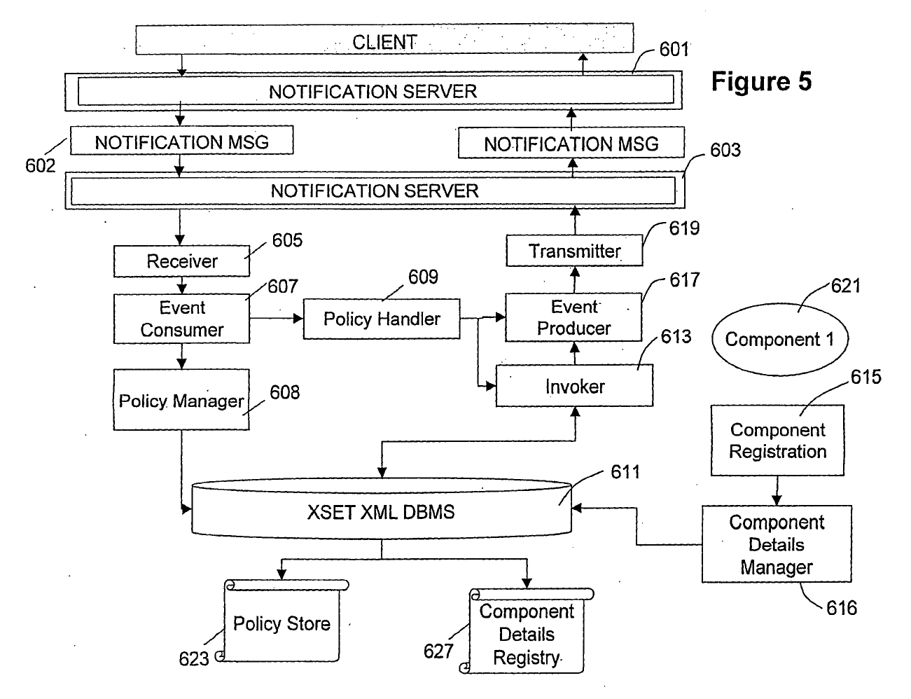

FIG. 5 illustrates the architecture of the software used in the first embodiment to provide a modifiable component-based computer.

FIG. 1 shows a telecommunication network operator's distributed billing system connected to a customer's home computer 12 via the Internet 14 and a Web Server 15. The billing system comprises four important sub-systems 2,4,6,8 interconnected by an intranet 10. The four sub-systems are a call data recording sub-system 2, a modifiable event-driven bill calculation sub-system 4, a modifiable event-driven bill production sub-system 6, and a billing system configuration station 8. The connection to the Internet from the billing system is made from the bill production sub-system 6. As is often the case in real commercial environments, the four sub-systems are located on different sites.

The call data recording system 2 is based on call data received from exchanges 10, 12 within the telecommunication network. Each of the exchanges is programmed to send the call data it collects through the Public Switch Telecommunication Network 15 (PSTN) via local area network 16 to call data recording computer 18. The call data recording computer 18 saves the call data in mass storage device 20. Billing event generation software is loaded from CD-ROM 17 on to computer 18. The call data may have a format similar to that shown in table 1 below:

TABLE 1

| | |
|---|---|
| Calling Number: | 020 7356 1111 |
| Called Number: | 01473 642222 |
| Start Time: | 10:23:52 18/10/03 |
| End Time: | 10:46:31 18/10/03 |

As will be understood by those skilled in the art the call data will not normally include the words in the above table. Instead the numerical/time data will be formatted in accordance with a predetermined format for example it might be presented as four pieces of American Standard Code for Information Interchange (ASCII) text, or the time element might be presented in a predetermined time format.

The bill event generation software, like much software for business computers, runs continuously on the computer 18. The running software operates the computer 18 to monitor billing dates for each calling number (it will be remembered that a calling number equates to a customer in many cases) and send a “Bill Due” event message to the bill calculation sub-system 4 each time the due date for a customer bill is reached. The “event” message is an eXtensible Mark-up Language XML document formatted in accordance with the schema which will be described below with reference to FIG. 2. Those skilled in the art will have little difficulty in providing a program which generates and communicates messages like the “Bill Due” event message.

The “Bill Due” event message is sent from the call data recording computer 18 to the bill calculation computer 26 via intranet 10 and local area network 24. The bill calculation computer 26 has software from CD-ROM 27 installed upon it. As will be described in more detail below with reference to FIG. 5, CD-ROM 27 provides policy database management software, policy handling software, and component-based bill calculation software whose operation is modifiable by way of updating policies stored in local policy database 28. It should be understood it is anticipated that modifiable components such as these might be supplied to developers via the Internet, perhaps in return for payment of a fee. Thus, rather than obtaining the component-based bill calculation software from the CD-ROM 27, the computer 26 could be connected via the local area network 24 to the global Internet 14 and the administrator of the billing computer 26 could download similar components from a component server elsewhere on the Internet 14. The component-based bill calculation software responds to the receipt of a “Bill Due” event message from the call data recording system 2 by generating a “Bill Calculated” event message and then sending this to the bill production sub-system 6.

The bill production sub-system 6 comprises a local area network 34 connected to the intranet 10, and further connected to a bill production computer 30 and a bill printer 32. Policy database management software and policy handling software similar to that provided for the bill calculation computer 26 on CD-ROM 27 is provided on the CD-ROM 36 for the bill production computer 30. Also provided on the CD-ROM 36 is component-based bill production software whose operation is modifiable by way of updating policies stored in local policy database 38.

FIG. 2 shows that the top level event specification consists of six elements. Each event type has a unique event-id 201, a globally unique string which, as will be explained below, is used to trigger appropriate policies. The description element 202 is a text string intended to be read by people rather than processed automatically. The optional generationTime element 203 identifies when the specific event occurred while the optional timeToLive element 205 specifies for how long the event is relevant. Use of this information can allow certain events to be discarded if not handled in time, limiting unnecessary management traffic. The source element 207 identifies the computer which generated the event. The source element 207 has two sub-elements, a role sub-element 209 and an entity sub-element 211. The entity sub-element 211 identifies the software component which generated the event. It is useful in providing an address to which an acknowledgement or result can be sent once the event has been handled. The role sub-element 209 represents an a categorisation that can be useful in obtaining behaviour common to events from different sources. This can also be useful in triggering different processing in reaction to an event from the same source. The data element 213 has an open content model and allows any well-formed XML to be included. This is where any specific information relevant to the event can be included.

It will be understood by those skilled in the art that the event schema seen in FIG. 2 allows for the insertion of bill data (and indeed other types of data) into the data element 213. Hence, an XML document constructed in accordance with the schema shown in FIG. 2 and used in the present embodiment for an event message going from the call data recording sub-system 2 to the bill calculation sub-system 4 might be as shown below:

```
<event>
  <event-id> Bill Due </event-id>
  <description>This event is generated by Call data recording System
on the date on which a customer is to be billed arriving. It includes the call
data pertaining to that customer during the billing period</description>
  <generationTime>08:15:01</generationTime>
  <source>
    </role>
    <entity> Call Data Recording System </entity>
  </source>
  <data>
    <customer data>
      <name>
        Fred Bloggs
      </name>
      <address>
        123 Acacia Avenue
      </address>
    </customer data>
    <call data>
      <CallingNumber> 02073561111 </CallingNumber>
      <CalledNumber> 01473642222 </CalledNumber>
      <StartTime> 10:23:52 18/10/03 </StartTime>
      <EndTime> 10:23:52 18/10/03 </EndTime>
    </call data>
    <call data> ...call2 data...</call data>
    <call data> ...call3 data...</call data>
  </data>
</event>
```

It will be seen that the call data shown in Table 1 is carried within the above event document.

The bill calculation computer 26 reacts to the event document received from the call data recording computer 18 in accordance with a policy document stored in a database on mass storage device 28.

After calculating a user's bill from the supplied call data and in accordance with one or more policies stored in policy store 28, the bill calculation computer 26 sends a “Bill Calculated” event to the bill production computer 30. An example of such an event follows:

```
<event>
  <event-id> Bill Due </event-id>
  <description>This event is generated by Call data recording
System on the date on which a customer is to be billed arriving. It
includes the call data pertaining to that customer during the
billing period</description>
  <generationTime>08:15:01</generationTime>
  <source>
    </role>
    <entity> Bill Calculation Sub-System </entity>
  </source>
  <data>
    <customer data>
      <name>
        Fred Bloggs
      </name>
      <address>
        123 Acacia Avenue
      </address>
    </customer data>
    <bill data>
      <LocalCalls> 123 </LocalCalls>
      <NationalCalls> 456 </NationalCalls>
      <MobileCalls> 789 </MobileCalls>
      <InternationalCalls> 1011 </InternationalCalls>
      <Line Rental> 1350 </Line Rental>
      <Rebate> 500 </Rebate>
    </bill date>
  </data>
</event>
```

It is to be understood that the present embodiment uses events to distribute knowledge of system state. For example, when a user indicates via their computer 12 that they would like to receive their bills in electronic form, this information causes the Web Server 15 to generate a database update event to the customer details databases stored on mass storage devices 28 and 38.

Returning to the operation of the bill calculation computer 26, because the bill calculation is carried out in accordance with a policy document stored in the policy database 28, it is easy for an administrator using administration computer 8 to update the operation of the billing computer 26 by updating the contents of the database stored in the mass storage device 28. The ability to modify the operation of the bill calculation computer 26 in this way is clearly useful to a telecommunication network operator that wishes to introduce a new billing policy—for example, reducing a customer's bill if they elect to receive their bill electronically rather than in paper form. The way in which the updating of the policy database 28 is effective to update the operation of the bill calculation computer 26 will be described below with reference to FIG. 5.

The overall structure of a policy (as, for example, stored in bill calculation policy database 28 or bill production policy database 38) is shown in FIG. 3. The top level policy specification consists of five elements. The policy-id 301, description 303, subject component 305, event-id 307, and rule 309 elements are described in detail below.

The policy-id 301 is a string intended to be globally unique. It is intended to be automatically processed and allows a policy to be unambiguously referenced. The description element 303 is an optional text string which is intended primarily for a human reader of the policy. It can be used to convey any additional information which is not intended for automated processing.

The subject element 305 identifies the component whose behaviour is modified if the policy is modified.

The policy specification presented here is assumed to work with an event-based approach to distributing knowledge of system state. In this case a policy specifies the behaviour that the policy handling software should exhibit when a particular event occurs. The event-id element 307 indicates which event triggers the policy. When an event is detected, relevant policies must be activated. It is assumed that a policy is triggered by a single event. The event-id element 307 is a globally unique string, corresponding to the event-id (FIG. 2, 201) found in the event document which triggers the policy.

Every policy includes one or more rule elements 309. These specify the behaviour that should result from the occurrence of the event which triggers the policy. Each rule element 309 contains the following fields:

First is the optional <rule-id> 312 which includes a identifier for the particular rule.

This is followed by an optional condition element 313. The <condition> element 313 consists of the sub-elements <BooleanExpression>, <true> and <false>. The BooleanExpression element provides the condition predicate that will be evaluated by the policy handling software obtained from the CD-ROM 27 or the CD-ROM 36. There is a number of things this string can include, which depend on the semantics of the Policy Handler class included within the policy handling software. First, the BooleanExpression may contain a string with a syntax recognisable by the Policy Handler. The policy handler will read the string in and evaluate it as is. For instance, the string may be a predicate expressed directly in Java syntax (e.g. a>3 && b==4), or alternatively in a policy handler-specific way (e.g. a greaterThan 3 AND b equals 4). Using the Java syntax to express the condition is easier because the symbols >, ==, 3 and 4 are directly parsable and understood by Java per se as they are Java symbols and it is only the symbols a and b that need make sense in the policy handler, i.e. the policy handler needs to know what a and b mean. Using a policy handler-specific way to express the predicate complicates the operation of the policy handler software, since it is on the policy handler to parse and understand not only a and b but all other symbols, i.e. greaterThan, AND and equals. Second, the string may contain an identifier for a condition. In this case, the policy handler will use the identifier to invoke a condition evaluating method/program (either local or remote, depending on whether the condition checks the state in the local or some remote context) that returns true or false. Following this, there are the <true> and <false> elements which both point to set of rules to be executed provided the condition evaluates to true or false respectively.

The <action> element 321, of which there is at least one in each rule element 309, describes the action to be undertaken (the action will inevitably be undertaken if no condition element is present in the associated rule). The action element contains a <target> 323 that indicates the component, or method or function within a component to invoke. There may be more than one <action> to be invoked when the condition evaluates to true. Also included within the action element is a context sub-element 326 which is used to identify a method or procedure to be invoked on the target component and which may contain one or more parameters to be passed to that component. It is to be noted that the target component 323 need not be the same as the subject component 305—often, the behaviour of the subject component 305 will be made flexible by having it make a method call which is dependent on the target 323 and context 326 sub-fields of the action field 321.

Next is the <rules> element 327 that introduces a set of additional rules to be executed in sequence of the above condition-action/s structure. These rules can be indicated either through a rule identifier, i.e. <rule-id>, which points to the particular rule to be used or by explicitly describing the rules, using the embedded element <rule>, as additional condition-action/s structures. In case the rule-id is used, we assume that the explicit XML documents describing the referred to rules exist separately and can be retrieved by the policy handler from a rule database, e.g. XSet. An equivalent body of Java code follows:

if (...){ //rule 1
...// some actions
}
if (...) { //rule 2
... //some actions
}

An example policy which might be used in the billing system of FIG. 1, and in particular, stored on the billing computer 26, is given below.

```
<policy>
  <policy-id>ElectronicBillingRebate</policy-id>
  <description>
    This policy reduces a customer's bill by £5 if they elect to
receive their bill in electronic form.
  </description>
  <subject> Bill Calculation Sub-System </subject>
  <event-id> BillDue </event-id>
  <rule>
    <rule-id> 1234 </rule-id>
    <condition>
      <BooleanExpression>
        IsBilledElectronically == true
      </BooleanExpression>
      <false>
        <action>
          <target> Bill Calculation Sub-System </target>
          <context>
            <method>
              <name> calculateBill( ) </name>
              <parameter> CustomerID </parameter>
              <parameter> Bill# </parameter>
              <parameter> Call Data[] </parameter>
            </method>
          </context>
        </action>
      </false>
    </condition>
      <action>
        <target> Bill Calculation Sub-System </target>
        <context>
          <method>
            <name> rebateBill( ) </name>
            <parameter> CustomerID </parameter>
            <parameter> Bill# </parameter>
            <parameter> 500 </parameter>
          </method>
        </context>
      </action>
      <action>
        <target> Bill Calculation Sub-System </target>
        <context>
          <method>
            <name> calculateBill( ) </name>
            <parameter> CustomerID </parameter>
            <parameter> Bill# </parameter>
            <parameter> Call Data[] </parameter>
          </method>
        </context>
      </action>
    </rule>
  </policy>
```

It will be seen that the above policy is triggered on the arrival of a customer bill due event (like the one shown above) and, depending on whether the customer has elected to be receive a bill electronically, applies a rebate to the customers bill prior to sending a “Bill Calculated” event to the bill production computer 30 in order to trigger the generation of a bill. The reaction to that event by the bill production computer 30 is also dependent upon a policy document, like that shown below:

```
<policy>
  <policy-id>ElectronicBillingImplementation</policy-id>
  <description>
    This policy selects between an electronic bill and a customer bill
dependent on the customer's preference.
  </description>
  <subject> Bill Production Sub-System </subject>
  <event-id> BillCalculated </event-id>
  <rule>
    <rule-id> 1235 </rule-id>
    <condition>
      <BooleanExpression>
        IsBilledElectronically == true
      </BooleanExpression>
      <false>
        <action>
          <target> Bill Production Sub-System </target>
          <context>
            <method>
              <name> printBill( ) </name>
              <parameter> CustomerID </parameter>
              <parameter> Bill# </parameter>
              <parameter> Bill Data[] </parameter>
            </method>
          </context>
        </action>
      </false>
    </condition>
    <action>
      <target> Bill Calculation Sub-System </target>
      <context>
        <method>
            <name> generateElectronicBill( ) </name>
            <parameter> CustomerID </parameter>
            <parameter> Bill# </parameter>
            <parameter> Bill Data[] </parameter>
        </method>
      </context>
    </action>
  </rule>
</policy>
```

It will be seen how the above policy would simply result in customers who had requested an electronic bill receiving their bills in electronic form, and those who had not receiving their bills in paper form.

A data structure for representing a software component used in this embodiment is shown in FIG. 4.

The top-level includes four elements relating to characteristics of the component represented by the data structure. The first element is simply the component's name 401 used to uniquely identify the component. The second element 403 is used to list events which are:

a) handled by the component (the consumed element 409); and
b) generated by the component (the produced element 411)

An identifier (413, 417) for each of the events handled or generated by the component is also included.

The next element is an element 405 listing the policies which influence the behaviour of this component in response to the receipt of an event consumed by the component. Each policy has a policy-id 417 to identify it.

The next element 407, called capabilities contains similar parameters to those seen in conventional component models, such as the CORBA Component Model or the component model used in Web Services.

Each capability has one or more operation elements 419 which, in common with conventional component models, provide the operation with a name 421, and for any input parameters 423, a name 425 and a type 427 and, similarly, for any output parameters 429, a name 431 and a type 433.

This information is useful to an administrator who wishes to supply a new policy to configure the operation of the bill calculation sub-system and the bill production sub-system. It will be understood from what has been said above how the introduction of the above two policies will on the one hand modify the bill production sub-system 6 to produce a paper or an electronic bill dependent on the customer's preference, and on the other hand modify the operation of the bill calculation sub-system 4—such modification (which, as explained below, need not the require the software running on the bill calculation computer and the bill production computer to be re-compiled or re-started) requires the person writing the target 323 and context 326 sub-elements to know the names of the methods offered by the target component, and the names and types of the parameters that method requires and returns. The name of the method is provided in the name field 439, and its input and output parameters and types are provided by sub-elements 441 to 451.

Thus, an XML document representing a bill calculation component running on the bill calculation computer 26 might be as follows:

```
<component>
  <name> Bill Calculation Sub-System </name>
  <events>
    </produced>
    <consumed> BillDue </consumed>
  </events>
  <policies>
    <policy-id> ElectronicBillingRebate <policy-id>
  </policies>
  <capabilities>
    <operation>
      <name> calculateBill( ) </name>
      <input>
        <name> CustomerID </name>
        <type> Integer </type>
        <name> Bill# </name>
        <type> Integer </type>
        <name> Call Data </name>
        <type> Call Data[] </type>
      </input>
    </operation>
    <operation>
      <name> rebateBill( ) </name>
      <input>
        <name> CustomerID </name>
        <type> Integer </type>
        <name> Bill# </name>
        <type> Integer </type>
        <name> Rebate Amount </name>
        <type> Integer </type>
      </input>
    </operation>
    <operation>
      <name> isBilledElectronically( ) </name>
      <input>
        <name> CustomerID </name>
        <type> Integer </type>
      </input>
      <output>
        <name> isBilledElectronically </name>
        <type> Boolean </type>
      </ouput>
    </operation>
  </capabilities>
</component>
```

The software included on the CD-ROMs 27 and 36 will now be explained in more detail with reference to FIG. 5. As mentioned above, that software includes policy database management software, policy handling software, and component-based bill calculation software whose operation is modifiable by way of updating policies stored in local policy database 28. Each one of the telecommunications operator's computers 15, 18, 26, 30 has software installed upon it which allows the sending of event messages between them. The software necessary to do this is shown as the notification server software 601, 603 in FIG. 5.

The policy handling software is written using the Java programming language and consists of the following Java classes: the Receiver class 605, an Event Consumer class 607, Policy Manager class 608, Policy Handler class 609, an Invoker class 613, a component registration class 615, Component Details Manager 616, an Event Producer class 617 and a Transmitter class 619. All of these classes form an application program referred to as a “container” below. Also stored within the memory of the bill calculation computer 26 is XML Database software 611 (the XSET XML database is used in this specific embodiment), and a modifiable bill calculation software component 621 also written in the Java programming language.

Receiver 605

This is the principal class that initiates the container with the main method. When the Receiver 605 is run, it firstly initialises the container. Then, a reference to a Receiver object is published to a remote method invocation (RMI) registry so that the notification server program 601 on the computers 18, and 34 can contact the container. The Receiver 605 consumes events sent to the container by those computers and responds by producing generate-Bill events. Upon consumption of an event a Transaction Context object is created and the Event Consumer 607 is contacted. When producing an event, the Transmitter 619 uses the getEventSourceEntity( ) method (see below) of the Transaction Context object in order to retrieve the destination to which the event is to be sent.

Transaction Context

This class records information relevant to every new transaction—a transaction starts as soon as an event is consumed. The transaction-related information captured in the Transaction Context object is the event source's identity—thus this object is used in keeping a record of an address to which an acknowledgement that the event has been handled (or that event handling has in some way failed) is to be sent. It will be remembered that this information is contained in the entity sub-element (FIG. 2: 211) of the source element 207 of the event. The Transaction Context object provides getter [getEventSourceEntity( )] and setter methods [setEventSourceEntity( )] for this data. The Transaction Context object is created at the Receiver 605, updated by the Event consumer 607 and consulted by the Policy Handler 609. It is an object exchanged between Receiver 605, Event Consumer 607 and Policy Handler 609 in order to provide to all a common view of useful transaction-related information.

Event Handler 607

This class is responsible for handling all consumed events. It contains the handleEvent( ) method and getassociatedPolicy( ) method. The event XML document and a Transaction Context object are passed to the handleEvent( ) method by the Receiver 605. The handleEvent( ) method firstly parses the event XML document to generate a document object model (DOM) tree and then unwraps the data part from the rest of the event DOM, where data represents the content to process i.e. the call data in the present example. It will be remembered that the data is contained in the data element 213 of the event. The getassociatedPolicy( ) method retrieves from the Policy Store 623 (see below) the relevant policy based on the event-id found in the event-id element 201 of the event and the event-id element 307 of the policies contained within the database 611. If the consumed event involves storing a policy, then the getassociatedPolicy( ) method retrieves an administrative policy which, as will be explained in more detail below, specifies how events which contain new policies to be saved in the Policy Store 623 should be handled. All retrieved policies are parsed before being passed onto the Policy Handler 609.

Policy Handler 609

This class handles the retrieved Policies. It contains the following methods: handlePolicy( ), validatePolicy( ), analysePolicy( ) and executeAction( ). The Event Consumer 607 passes the retrieved policy to the handlePolicy( ) method. The Policy Handler uses the validatePolicy( ) method to check the validity of the policy.

Next, the analysePolicy( ) method interprets the policy. This interpretation involves evaluating any BooleanExpression (FIG. 3: 315) within any condition of the policy. Corresponding actions are found to recover details about which methods of the legacy billing software component to use. These details (the name of the method and the parameters to be passed to the method) are the values contained in the context element of the policy (FIG. 3, 326). The recovered details and the data found in the context element 326 of the policy are used by the executeAction( ) method which then communicates with the Invoker 613. In case the chosen policy is an administrative one, analysePolicy( ) will save the content, represented by the data found in the data element 213 of the event, to the Policy Store 609.

XSET XML Database 611

This is an internal database that stores:

i) Policy Store 623 holding one or more policies; and
ii) Component Details registry 627.

The present embodiment uses XSet, an in-memory and XML-based database. In-memory databases are a special type of database in which all data is stored in memory instead of in files on a hard disk in order to provide faster access to the data. Details of XSet can be found in The XSet XML Search Engine and XBench XML Query Benchmark, Technical Report UCB/CSD-00-1112, Ben Yanbin Zhao, Computer Science Division, University of California, Berkeley, 2000. The Policy Store 623 provides access methods to its content. Specifically, storeInXSet( ) stores XML documents either in the form of DOM trees or read in from files and queryXSet( ) retrieves XML documents by executing a query expression, and deleteFromXSet( ) which deletes XML documents stored in the database 611.

Invoker 613

This class is responsible for altering the behaviour of an executing component when a policy to which it is subject is updated in the Policy Store 623. The Policy Handler 609 passes to the invokeAction( ) method of the invoker 613 the name of the method to invoke execution environment together with the input parameters found in the policy. By using the Java Reflection API, the Invoker is arranged, whilst executing, to call the method on the component identified in the policy, using the parameters set forth in the policy. Thus, the method call made in reaction to the receipt of an event depends on the policy currently in place for specifying how the component should react to the event. The selection of a method to run at run-time means that the behaviour of what might be viewed as a distributed billing application is adaptable at run-time without having to re-compile or re-start any programs running in the system.

Component Details Registry 627

This is a part of the XSET database store the component details (FIG. 4) of components stored in the same computer as the database. Access methods are provided namely, put( ) for store, get( ) for retrieval, remove( ) for delete and contains Component( ) for checking the inclusion of a Component reference. Each member of the registry implements the following Java interface, which is just a marker i.e. it only marks each member as a Component.

Public Interface Component { }

The only module that contacts the Component Registry 615 is the Invoker 613.

When a Container instance is started, the Container initially registers with a notification server program 601, which has been loaded onto a notification server computer (not shown), to announce its interest in listening for certain types of event specific to the Container. Each time the call data recording computer 18 sends a Bill Due event to the Container (which event includes call data), the event firstly reaches a notification server program 601, which has been loaded onto the notification server computer and which the computers (15, 18, 26, 30) are registered with. Upon reception of the event, the notification server program 601 wraps the event up in a notification message 602 (i.e. the event is enclosed within the notification message 602) and delivers the message to the notification server program 603 that the Container is registered with. The notification server program 603 unwraps the event part from the message (i.e. extracts it) and sends it to the Receiver 605.

At the time the billing system is initialised, the Receiver 603 consumes two events. These events are sent by an administrator operating administration computer 8. The events contain in their data elements 213 two administrative policies. The event-id elements 307 of both policies do not contain any values, indicating that the policy is to be activated as soon as it is received. The first policy determines that upon consumption of a StorePolicy event, the data contained in the data element 213 of that StorePolicy event should be stored in the Policy Store 623. The second policy indicates that when a QueryPolicy event is consumed, the query contained in the data element 213 of that QueryPolicy event should be run on the contents of the Policy Store 623. Both administrative policies are stored in the Policy Store 623.

The Receiver 605 consumes events arriving at it from one of computers 8, 15, 18, 26, 30 through notification servers 601/603. The event is parsed (703) using the Xerces Java™ Parser (from The Apache XML Project) and a Transaction Context object is created Consumer 607. Both event and transaction context object are passed through to the Event Consumer 607, which initially unwraps the data from the event. The data represents either the call data for a customer or a new policy and is contained in the data element 213 of the event. Additionally, the Event consumer 607 updates the Transaction Context object with the event-id, information indicated by the value of the source element 207 of the event. Next, the Policy Store 623 is contacted to retrieve any policies relevant to the received event. Important information for this search is the event-id contained in the event-id element 201 of the event.

The handling of call data events with component methods that are run upon the consultation of a policy will now be described.

The Event Consumer 607 contacts the Policy Store 623. The search for a relevant policy yields a Policy, which is passed to the Policy Handler 609 along with the data contained in the data element 213 of the event and the Transaction Context object. The next step is to analyse, i.e. interpret, the policy. The aim of the analysis is to extract the information that describes the Component method which should be used. The specific information requested is the name of the method to invoke and the parameters to be passed to the method. This information is contained in the context element 326 of the policy. Subsequently, the name method is passed onto the invoker module with the request to call the specified method supplying the parameters provided. When the method is run, the Policy Handler 609 requests that the Invoker 613 invokes the method specified in the selected Policy, passing also the parameter (from data element 213). The invoker 613 invokes the requested action. The return from this action is propagated all the way back to the Event Producer 617 which respectively produces a Bill Calculated event to send to the bill production computer 30.

The handling of administrator-generated events (e.g. StorePolicy and QueryPolicy events) will now be described.

In the beginning the event is consumed by the Receiver 605. Then it gets parsed and a Transaction Context object is created. Both parsed event and transaction context object are sent to the Event Consumer 607 which unwraps the data, contained in the data element 213, from the event and updates the transaction context object with the event source URI from the source element 207 of the event. Next, the Policy Store 623 is checked for administrative policies. These policies are created by the Administrator and are the ones that the Container read in initially as described above. These policies determine that the Policy Store 623 is the data store to target when handling the content of administrator-generated events. The retrieved administrative policy is returned to the Event Consumer 607 and then passed along with the data to the Policy Handler 609. There, the policy is validated and analysed after which the Policy Handler 609 invokes the action specified in the policy to either store or retrieve content from the Policy Store 623. The Policy Store 623 then returns either query results or a success/failure indication of the operation. The results are propagated back to the Receiver 605 which produces an Acknowledgement or QueryResults event. Either produced event is finally returned to the initial event source through the notification servers 601/603.

From the above description it will be seen how the first embodiment offers the run-time modification of a distributed application as seen in the prior-art. However, it will also be seen how a modifiable method call in a component is modified at run-time in dependence on a policy stored on the same machine as the component whose operation is modified (and that this is true of each of a plurality of computers involved in running a distributed application program). This obviates the need for complex software to handle dynamic invocation of methods stored on another computer and hence reduces the cost of providing a run-time modifiable distributed computer without sacrificing modifiability of the operation of the distributed computer.

Although in the above described embodiment an in-memory based database (XSet) was used, in other embodiments any persistent data store such as those available from IBM, Oracle and Sybase would be suitable. Furthermore the Store could be remote from the billing Computer 26, e.g. linked via the LAN 24.

In the above embodiment, the various sub-systems were all owned by one telecommunications company. However, in other embodiments, the sub-systems might be owned by different companies—the use of a standard data encoding scheme (XML) making the integration of sub-systems owned by different companies relatively straightforward.

1. A distributed computer comprising at least two interconnected computers, each of said computers storing:
i) component process code executable to provide a process forming part of a distributed software application;
ii) event messaging code executable to receive one or more event messages from another of said computers;
iii) event reaction rule storage code executable to store, in an updateable store, one or more event reaction rules which include one or more calls to procedures in said component process in reaction to the receipt of said event message;
iv) event reaction interpretation code executable to operate said computer in accordance with said event reaction rules;
v) event reaction rule modification code executable to allow a user to modify said event reaction rules stored in said updateable store whilst said component process is running and thereby alter the operation of said distributed software application whilst it is running.

2. A distributed computer according to claim 1 wherein each of said computers stores component procedure interface information to be associated with said component process code.

3. A distributed computer according to claim 1 wherein comprises computational reflection code executable to convert method or procedure call data in said event reaction rule into a corresponding method or procedure call for execution.

4. A distributed computer according to claim 1 in which said event messages are structured in accordance with event schema data accessible to each of said computers.

5. A distributed computer according to claim 4 in which said event messages comprise a combination of event data and mark-up data.

6. A distributed computer according to claim 5 in which said event messages are sent as encoded text.

7. A distributed computer according to claim 1 in which said process modification code is executable to configure said process by specifying a method or procedure to be called and the parameters to accompany said method or procedure call.

8. A distributed computer according to claim 7 in which said specified method or procedure is running on the other of said computers.

9. A distributed computer according to claim 1 in which said interconnected computers comprise an administration computer having installed thereon graphical user interface code executable to allow an administrator to update said event reaction rules.

10. A distributed computer according to claim 1 in which said event reaction rules specify a method or procedure to be carried out in reaction to the reception of an event message.

11. A distributed computer according to claim 10 in which said event reaction rules further specify a condition to be tested, the carrying out of said action being conditional on said condition being met.

12. A distributed computer according to claim 1 in which each of said computers further stores database management code executable to provide a database store for said rules stored on said computer.

13. A distributed computer according to claim 1 in which each of said computers further stores component process details including names of one or more procedures or methods provided by said component process.

14. A distributed computer according to claim 13 in which said component process details further include names of one or more input parameters to be included with a method call and an indication of the type of those input parameters.

15. A distributed computer according to claim 13 further comprising graphical user interface code executable to enable a user to view said component process details.

16. A method of operating a distributed computer comprising a plurality of interconnected computers, said method comprising operating each of said computers to:
i) execute one or more component processes which form part of a distributed program running on said distributed computer;
ii) store one or more event reaction rules, said event reaction rule including a reference to one or more procedures within said component process;
iii) provide a user with an interface allowing updating of said event reaction rules; and
iv) responsive to the receipt of an event message at said computer, to interpret a corresponding event reaction rule and thereby execute said one or more procedures referred to in said event reaction rule.
